(19) United States
(12) Patent Application Publication
(10) Pub. No.: US 2021/0178601 A1
(43) Pub. Date: Jun. 17, 2021

(54) DEVICE TO MONITOR STATE OF BALANCE OF ROBOT, METHOD OF OPERATION FOR SUCH DEVICE, AND COMPUTER READABLE MEDIUM

(71) Applicant: TRIPLE WIN TECHNOLOGY(SHENZHEN) CO.LTD., Shenzhen (CN)

(72) Inventor: TZONG-YI LEE, New Taipei (TW)

(21) Appl. No.: 16/853,966

(22) Filed: Apr. 21, 2020

(30) Foreign Application Priority Data
Dec. 16, 2019 (CN) 201911290091.6

(51) Int. Cl. B25J 9/16; G06T 7/73; G06T 3/40

(52) U.S. Cl. CPC B25J 9/1697; B25J 9/1664; G06T 3/4038; G06T 7/75

(57) ABSTRACT

A method for determining state of balance of a robot and applying corrections as necessary includes: acquiring an image set of initial images taken by a photographing device when a robot is balanced, and acquiring coordinates of each initial image in the image set. An image model is generated by arranging and stitching the initial images according to the coordinates and setting a balance threshold of the image model. A determination image is acquired in real time and the determination image is compared with the image model to obtain a difference value which is measured against the balance threshold, to determine a balance state of the robot. A device for determining robot balance is further provided.

### FIELD

The disclosure generally relates to robot control, device and a method for judging the balance state of a robot.

### BACKGROUND

During the movement of a robot, the center of gravity of the robot may shift when engaging in a variety of actions, the robot may become unbalanced. If the imbalance cannot be adjusted in time, it may cause the robot to fall over or be damaged.

### BRIEF DESCRIPTION OF THE DRAWINGS

Implementations of the present technology will now be described, by way of embodiments, with reference to the attached figures.

FIG. 1 is a block diagram illustrating an embodiment of a robot balance determination device.

FIG. 2 is a block diagram illustrating an embodiment of a robot balance determination system.

FIG. 3 is a flowchart illustrating an embodiment of a method for determining the state of balance of a robot.

FIG. 4 is a schematic diagram of an embodiment of an image model.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”, it specifically indicates open-ended inclusion or membership in a so-described combination, group, series, and the like.

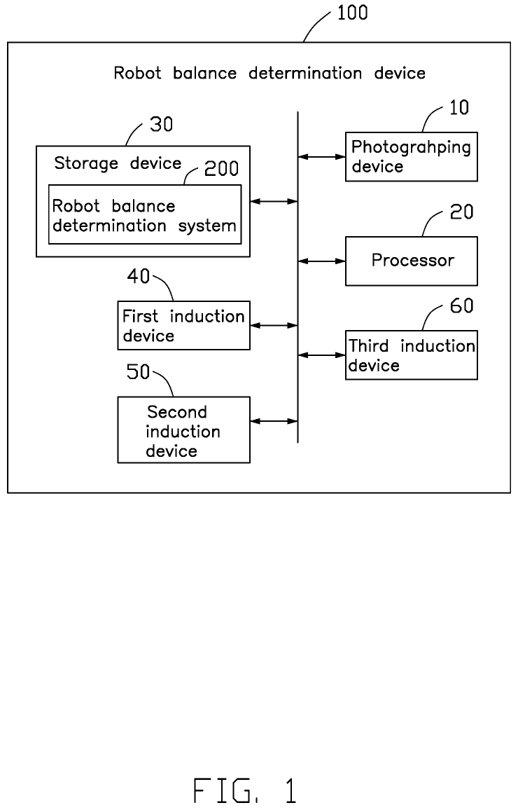

FIG. 1 illustrates an embodiment of a robot balance determination device 100. The robot balance determination device 100 includes a photographing device 10, a processor 20, a storage device 30, a first sensing device 40, a second sensing device 50, and a third sensing device 60.

The photographing device 10 is used to photograph at least one image around a robot.

In one embodiment, the photographing device 10 takes a plurality of initial images around the robot, and an image set is formed from the initial images.

In one embodiment, one or more photographing devices 10 take the robot as the axis, and sequentially take multiple initial images according to different shooting angles. The initial images can be used to obtain the environmental conditions around the robot, such as whether it contains landmark objects, or the relative positions of objects and the robot.

The number of images can be determined according to environmental conditions.

The initial images can be partially overlapped to ensure the continuity of an image model formed by the initial images.

In one embodiment, the photographing device 10 may only capture a plurality of initial images in front of the robot to obtain the environmental conditions in front of the robot.

When the robot is balanced, the robot can be stationary or in motion.

In one embodiment, the photographing device 10 is further configured to obtain a determination image according to a determination coordinate.

In one embodiment, the photographing device 10 may be a CCD photographing device, a binocular photographing device, or the like.

The processor 20 may include one or more central processors (CPU), a microprocessor, a digital processing chip, a graphics processor, or a combination of various control chips. The processor 20 may use various interfaces and buses to connect various parts of the robot balance determination device 100.

The storage device 30 stores various types of data in the robot balance determination device 100, such as program codes and the like. The storage device 30 can be, but is not limited to, read-only memory (ROM), random-access memory (RAM), programmable read-only memory (PROM), erasable programmable ROM (EPROM), one-time programmable read-only memory (OTPROM), electrically EPROM (EEPROM), compact disc read-only memory (CD-ROM), hard disk, solid state drive, or other forms of electronic, electromagnetic, or optical recording medium.

The first sensing device 40 senses the speed of the robot and a distance traveled by the robot to obtain a first sensing information.

In one embodiment, the first sensing device 40 includes a gravity sensor, and the first sensing information includes the speed and displacement of the robot. It can be understood that the first sensing device 40 may also include, but is not limited to, an acceleration sensor.

The second sensing device 50 is configured to sense the uprightness of the robot to obtain a second sensing information.

In one embodiment, the second sensing device 50 includes a gyroscope, and the second sensing information includes the azimuth of the robot. It can be understood that the second sensing device 50 may also include, but is not limited to, a magnetometer.

In another embodiment, the first sensing device 40 obtains the first sensing information when the robot is in balance and forms a first information set accordingly. The second sensing device 50 obtains the second sensing information when the robot is in balance and forms a second information set according to a plurality of second sensing information.

The third sensing device 60 is configured to sense a distance between the robot and a nearby object to obtain a third sensing information.

In one embodiment, the third sensing device 60 includes an ultrasonic sensor, and the third sensing information includes a distance information between the robot and nearby objects. It can be understood that the third sensing device 60 may also include, but is not limited to, an infrared sensor.

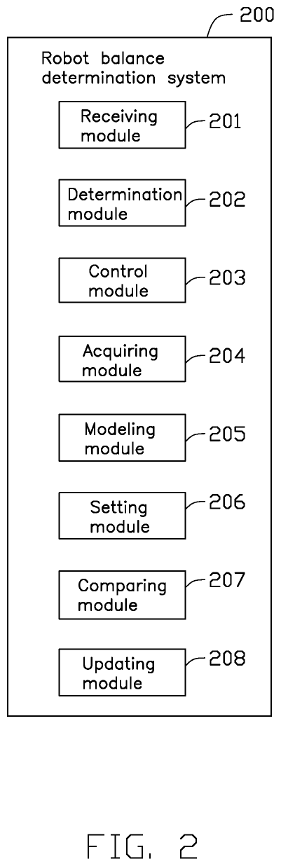

FIG. 2 shows a robot balance determination system 200 running in the robot balance determination device 100. The robot balance determination system 200 may include a receiving module 201, a determination module 202, a control module 203, an acquiring module 204, a modeling module 205, a setting module 206, a comparing module 207, and an updating module 208. In one embodiment, the above modules may be programmable software instructions stored in the storage device 30 and callable by the processor 20 for execution. It can be understood that, in other embodiments, the above modules may also be program instructions or firmware fixed in the processor 20.

The receiving module 201 receives the image set sent by the photographing device 10. The image set includes a plurality of initial images taken by the photographing device 10 when the robot is in good balance.

The receiving module 201 further receives a determination image sent by the photographing device 10.

The receiving module 201 further receives a first sensing information sent by the first sensing device 40 and a second sensing information sent by the second sensing device 50.

In other embodiments, the receiving module 201 further receives a first information set and a second information set. The first information set is a set of first sensing information obtained by the first sensing device 40 when the robot is in good balance, and the second information set is a set of second sensing information obtained by the second sensing device 50 when the robot is in good balance.

The receiving module 201 is further configured to receive a third sensing information sent by the third sensing device 60.

The determination module 202 is configured to determine a state of balance of the robot.

In one embodiment, the receiving module 201 receives the first sensing information sent by the first sensing device 40 and the second sensing information sent by the second sensing device 50. The determination module 202 sets a balance threshold and determines a balance state of the robot according to the first information, the second information, and the balance threshold. The balance state can include being in good balance and loss of balance.

The determination module 202 further sets a determination region according to the characteristics of the image model, and then determines the determination coordinates of the determination region.

The characteristics of the image model include the similarity of the regions in the image model, the coherence of the regions in the image model, and whether obvious features are included in the image model. For example, the similarity of regions in the image model is high. If one of the regions is used as the determination region, it is easy to cause determination errors. If the adjacent regions in the image model have continuity and repeatability, differences between the adjacent regions may be difficult to find, and such region should not be used as a determination region. If the image model has prominent and distinctive features, such as a region containing animal patterns that are significantly different from the surrounding environment, this region can be used as a determination region.

The determination module 202 is further configured to determine whether the difference value exceeds the balance threshold, so as to determine the state of the balance of the robot.

In other embodiments, the determination module 202 is further configured to compare the first information, the second information, and an auxiliary balance threshold to determine the balance state of the robot.

The control module 203 sends an instruction to photograph, so that the photographing device 10 captures an image.

The photographing instruction includes a first photographing instruction and a second photographing instruction. The control module 203 sends a first photographing instruction to control the photographing device 10 to take initial images. The control module 203 sends a second photographing instruction to the photographing device 10 to control the photographing device 10 to take a determination image.

The control module 203 is further configured to send an adjustment instruction to the robot to enable restoration of balance in the robot by self-adjustment.

The acquiring module 204 obtains the coordinates of each initial image in the image set.

In one embodiment, the acquiring module 204 establishes a coordinate system and sets the coordinates according to the relative position of each initial image and the robot. The coordinate system may be a rectangular coordinate system or a three-dimensional coordinate system.

The modeling module 205 arranges and stitches together the initial images in the image set according to the coordinates to generate the image model.

In one embodiment, the image model is a panoramic image.

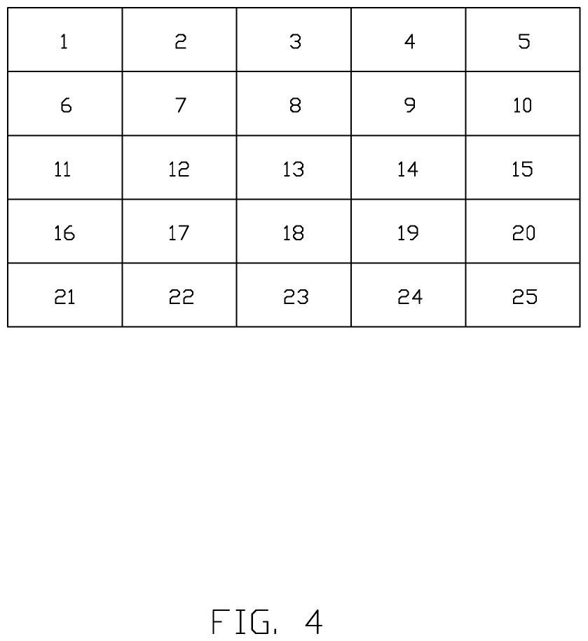

FIG. 4 shows an image model. The image model is formed by arranging and stitching twenty-five initial images arranged in a matrix, and each initial image is provided with corresponding coordinates, which are 1 to 25 respectively. The coordinates and arrangement method of the initial images can be adjusted according to the actual application scene.

The modeling module 205 is further configured to update the three-dimensional coordinates of each image region in the image model according to the third information.

The setting module 206 sets the balance threshold of the image model.

In one embodiment, the balance threshold is based on a degree of difference. For example, the balance threshold is a degree of difference between the image obtained according to the specified coordinates and the image in the same coordinate region in the image model.

In another embodiment, the balance threshold is a coordinate offset, for example, a difference between coordinates of an image obtained according to the specified coordinates and the same image region in the image model.

In one embodiment, the setting module 206 further sets the auxiliary balance threshold according to the first information set and the second information set. The auxiliary balance threshold can be an angle or an uprightness range.

The comparing module 207 compares the determination image and the image model to obtain a difference value.

In other embodiments, the comparing module 207 compares a coordinate of the determination image and a coordinate of an image region same with the determination image in the image model.

The updating module 208 generates a status information according to the first sensing information and the second sensing information and adjusts a reconstruction period of the image model according to the status information. The status information includes movement speed, acceleration, direction change, angle change, and so on. For example, if the environment around the robot changes or the robot is moving faster, the reconstruction period of the image model needs to be shortened to ensure the accuracy of the image model. If the robot speed is slow and the environment changes are small, the reconstruction period of the image model can be lengthened.

The modeling module 205 is further configured to re-create a new image model according to the reconstruction period, to replace the old image model.

The reconstruction period is the duration of a particular image model, so as to ensure that the current image model is consistent with the environment around the robot.

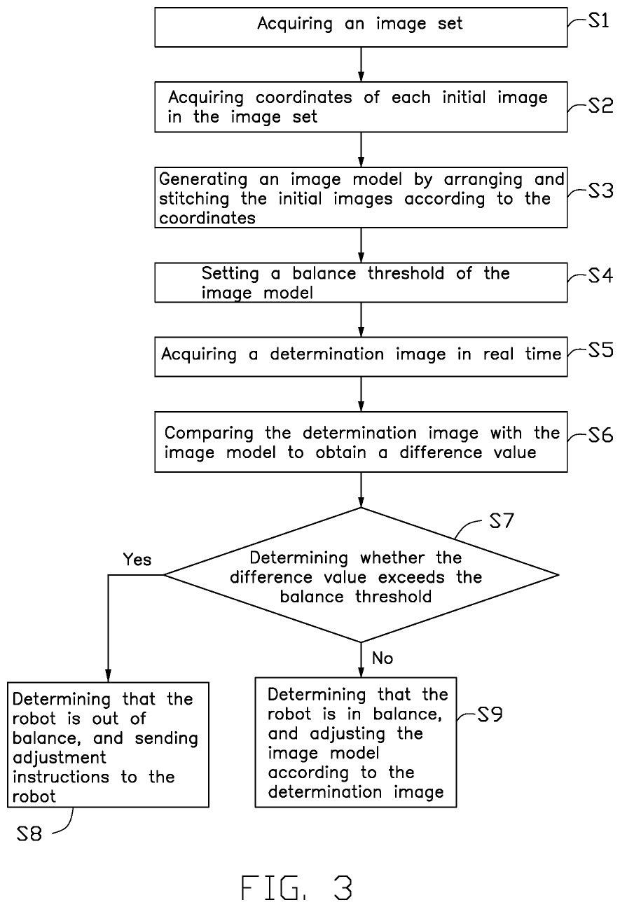

A robot balance determination method is illustrated in FIG. 3. The method is provided by way of embodiments, as there are a variety of ways to carry out the method. Each block shown in FIG. 3 represents one or more processes, methods, or subroutines carried out in the example method. Additionally, the illustrated order of blocks is by example only and the order of the blocks can be changed. The method can begin at block S1.

At block S1, an image set is acquired.

The image set is sent by the photographing device 10, and the image set includes a plurality of initial images taken by the photographing device when a robot is in good balance.

The step at block S1 may include: determining the balance state of the robot; acquiring a plurality of initial images when the robot is in balance, and forming the image set according to the initial images. When the robot is out of balance, an adjustment instruction is sent to the robot.

At block S2, coordinates of each initial image in the image set are acquired.

A coordinate system may be established and the coordinates may be set according to the relative positions of each initial image and the robot. The coordinate system may be a rectangular coordinate system or a three-dimensional coordinate system.

At block S3, an image model is generated by arranging and stitching together the initial images according to the coordinates.

The image model may be a panoramic image.

As shown in FIG. 4, the image model is formed by arranging and stitching twenty-five initial images arranged in a matrix, and each initial image is provided with corresponding coordinates, which are 1 to 25 respectively.

In one embodiment, after the step at block S3, the method further includes acquiring a third sensing information and adjusting the image model according to the third sensing information. The third sensing information includes a distance information between the robot and nearby objects. The modeling module 205 updates the three-dimensional coordinates of each image region in the image model according to the third sensing information.

At block S4, a balance threshold of the image model is set.

In one embodiment, the balance threshold is based on a degree of difference. For example, the balance threshold is a degree of difference between the image obtained according to the specified coordinates and the image in the same coordinate region in the image model.

In another embodiment, the balance threshold is a coordinate offset, for example, a difference between coordinates of an image obtained according to the specified coordinates and the same image region in the image model.

In one embodiment, the setting of the balance threshold is based on the robot's ability regarding the adaptive adjustment. For example, during the robot's movement, a tilt caused by its own movement or action can be adjusted according to its own gravity, then the tilt belongs to the normal range and is within the balance threshold range. The robot may be tilted more than a certain angle which is beyond adjustment by the robot's own sensed gravity. If the robot does not adjust the state, the robot will lose balance or even fall, and such state will exceed the balance threshold range.

At block S5, a determination image in real time is acquired.

A determination coordinate is determined according to the characteristics of the image model, and then the determination image according to the determination coordinates is obtained.

The characteristics of the image model include the similarity of the regions in the image model, the coherence of the regions in the image model, and whether obvious features are included in the image model. For example, the similarity of regions in the image model may be high. If one of the regions is used as the determination region, it is easy to cause determination errors. If the adjacent regions in the image model have continuity and repeatability, and difference is difficult to find between the adjacent regions, this region should not be used as a determination region. If the image model has distinctive and prominent features, such as a region containing animal patterns that are significantly different from the surrounding environment, this region can be used as a determination region.

At block S6, the determination image is compared with the image model to obtain a difference value.

In one embodiment, the difference value is a difference between a coordinate of the determination image and a coordinate of an image region same with the determination image in the image model. In another embodiment, the difference value is a degree of difference between the determination image and an image region having the same coordinates as the determination image in the image model.

At block S7, it is determined whether the difference value exceeds the balance threshold, so as to determine the balance state of the robot.

If the difference value exceeds the balance threshold, the process proceeds to block S8. If not, the process proceeds to block S9.

At block S8, it is determined that the robot is out of balance, and adjustment instructions are sent to the robot.

For example, the determined image has a coordinate of 8, but the determined image with a coordinate of 8 is located in an image region with a coordinate of 24 in the image model which exceeds the balance threshold range of 3, 7, 8, 9, and 13, thus the robot is determined to be out of balance.

After the robot receives the adjustment instructions, the robot will self-adjust and restore balance.

At block S9, it is determined that the robot is in balance, and the image model is adjusted according to the determination image.

when the balance state of the robot lost balance, an adjustment instruction may be sent to the robot to enable restoration of balance in the robot by self-adjustment.

In one embodiment, the determination image can replace the region in the image model to update the image model. In one embodiment, the method further includes: acquiring the first sensing information and the second sensing information; generating a status information according to the first sensing information and the second sensing information; and adjusting a reconstruction period of the image model according to the status information.

The status information may include the movement speed, the acceleration, the changes in direction, and changes in angle. The movement speed and the acceleration are changes in the speed of the robot's movements.

In one embodiment, steps at S1 to S3 are executed periodically according to the reconstruction period to re-establish the image model.

In another embodiment, the method further includes the steps as follows.

Firstly, a first information set and a second information set are acquired.

The first information set is a set of first sensing information acquired by the first sensing device 40 when the robot is balanced, and the second information set is a set of second sensing information acquired by the second sensing device 50 when the robot is balanced.

Secondly, the auxiliary balance threshold is set according to the first information set and the second information set.

Thirdly, the first sensing information and the second sensing information in real time are acquired.

The first sensing information and the second sensing information are compared with the auxiliary balance threshold to determine the balance state of the robot.

When the robot is balanced, it acquires the image set, the first information set, and the second information set through the first sensing device 40, the second sensing device 50, and the photographing device 10, and sets a balance threshold and an auxiliary balance threshold. The first sensing information and the second sensing information in real time is used to determine the balance state of the robot. By combining multiple means of balance determination, the accuracy of balance determination is enhanced, and the adaptability according to balance determination is enhanced.

The above method for determining the balance of a robot establishes an image model when the robot is in balance, sets the balance threshold of the image model, compares the determination image in real time with the image model to obtain the difference value, and determines the balance state of the robot according to the difference value and the balance threshold. The method controls the robot to adjust itself in timely manner.

The robot balance determination method reconstructs or replaces the image model to ensure the accuracy of the image model, thereby improving the accuracy of the robot's balance state determination.

Furthermore, the robot balance determination method may be combined with other balance determination methods, such as determination based on a gravity sensor and a gyroscope, to improve the accuracy of the robot balance determination and enhance precision of balance.

A person skilled in the art can understand that all or part of the processes in the above embodiments can be implemented by a computer program to instruct related hardware, and that the program can be stored in a computer readable storage medium. When the program is executed, a flow of steps of the methods as described above may be included.

In addition, each functional device in each embodiment may be integrated in one processor, or each device may exist physically separately, or two or more devices may be integrated in one device. The above integrated device can be implemented in the form of hardware or in the form of hardware plus software function modules.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

What is claimed is:

1. A device for monitoring state of balance of a robot, comprising:
a photographing device; and
a processor coupled to the photographing device and configured to:
acquire an image set sent from the photographing device, the image set comprising a plurality of initial images taken by the photographing device when a robot is balanced;
acquire coordinates of each of the initial images in the image set;
generate an image model by arranging and stitching together the initial images according to the coordinates;
set a balance threshold of the image model;
acquire a determination image in real time;
compare the determination image with the image model to obtain a difference value;
determine whether the difference value exceeds the balance threshold to determine a state of balance of the robot.

2. The device of claim 1, wherein the processor is further configured to:
adjust the image model according to the determination image, if the robot is balanced.

3. The device of claim 1, wherein the difference value is a difference between a coordinate of the determination image and a coordinate of an image region same with the determination image in the image model.

4. The device of claim 1, wherein the difference value is a degree of difference between the determination image and an image region having the same coordinates as the determination image in the image model.

5. The device of claim 1, wherein the processor is further configured to determine a determination coordinate according to a model characteristic of the image model; and
the photographing device is further configured to acquire the determination image according to the determination coordinates.

6. The device of claim 1, wherein the processor is further configured to:
send an adjustment instruction to the robot to enable restoration of balance in the robot by self-adjustment, when the balance state of the robot lost balance.

7. The device of claim 1, wherein the device further comprises a first sensing device and a second sensing device;
the first sensing device is configured to sense the speed of the robot and a distance travelled by the robot to form first sensing information, and the second sensing device is configured to sense the uprightness of the robot to form a second sensing information;
the processor is further configured to:
acquire the first sensing information and the second sensing information;
generate a status information according to the first sensing information and the second sensing information; and
adjust a reconstruction period of the image model according to the status information.

8. The device of claim 7, wherein the processor is further configured to:
acquire a first information set and a second information set, the first information set comprising a plurality of first sensing information when the robot is balanced, and the second information set comprising a plurality of second sensing information when the robot is balanced;
set an auxiliary balance threshold according to the first information set and the second information set;
acquire the first sensing information and the second sensing information in real time;
comparing the first sensing information and the second sensing information with the auxiliary balance threshold to determine the balance state of the robot.

9. The device of claim 1, wherein the device further comprises a third sensing device configured to sense a distance between the robot and a nearby object to obtain a third sensing information; and
the processor is further configured to adjust the image model according to the third sensing information.

10. A method for monitoring state of balance of a robot, comprising:
acquiring an image set, the image set comprising a plurality of initial images taken by the photographing device when a robot maintains balance;
acquiring coordinates of each of the plurality of initial images in the image set;
generating an image model by arranging and stitching the initial images according to the coordinates;
setting a balance threshold of the image model;
acquiring a determination image in real time;
comparing the determination image with the image model to obtain a difference value;
determining whether the difference value exceeds the balance threshold to determine a state of balance of the robot.

11. The method of claim 10, further comprising:
adjusting the image model according to the determination image, if the robot is balanced.

12. The method of claim 10, wherein the difference value is a difference between a coordinate of the determination image and a coordinate of an image region same with the determination image in the image model.

13. The method of claim 10, wherein the difference value is a degree of difference between the determination image and an image region having the same coordinates as the determination image in the image model.

14. The method of claim 10, wherein a process of acquiring the determination image comprises:
determining a determination coordinate according to a model characteristic of the image model; and
acquiring the determination image according to the determination coordinates.

15. The method of claim 14, further comprising:
acquiring a first sensing information of the speed of the robot and a distance travelled by the robot and a second sensing information of the uprightness of the robot;
generating a status information according to the first sensing information and the second sensing information; and
adjusting a reconstruction period of the image model according to the status information.

16. The method of claim 15, further comprising:
acquiring a first information set and a second information set, the first information set comprising a plurality of first sensing information when the robot is balanced, and the second information set comprising a plurality of second sensing information when the robot is balanced;
setting an auxiliary balance threshold according to the first information set and the second information set;
acquiring the first sensing information and the second sensing information in real time; and
comparing the first sensing information and the second sensing information with the auxiliary balance threshold to determine the balance state of the robot.

17. The method of claim 10, further comprising:
acquiring a third sensing information of a distance between the robot and a nearby object to obtain a third sensing information; and
adjusting the image model according to the third sensing information.

18. The method of claim 10, further comprising:
sending an adjustment instruction to the robot to enable restoration of balance in the robot by self-adjustment, when the balance state of the robot lost balance.

19. A computer readable storage medium having stored thereon instructions that, when executed by at least one processor of a computing device, causes the processor to perform a method for monitoring state of balance of a robot, wherein the method comprises:
acquiring an image set, the image set comprising a plurality of initial images taken by the photographing device when a robot maintains balance;
acquiring coordinates of each of the plurality of initial images in the image set;
generating an image model by arranging and stitching the initial images according to the coordinates;
setting a balance threshold of the image model;
acquiring a determination image in real time;
comparing the determination image with the image model to obtain a difference value;
determining whether the difference value exceeds the balance threshold to determine a state of balance of the robot.
